(19) United States
(12) Patent Application Publication
(10) Pub. No.: US 2004/0199471 A1
(43) Pub. Date: Oct. 7, 2004

(54) Rights trading system

(76) Inventor: Thomas P. Hardjono, Winchester, MA (US)

Correspondence Address: KENYON & KENYON, 1500 K STREET, N.W., SUITE 700, WASHINGTON, DC, 20005, US

(21) Appl. No.: 10/402,959

(22) Filed: Apr. 1, 2003

(51) Int. Cl. G06F 17/60

(52) U.S. Cl. 705/50

(57) ABSTRACT

A system and method for trading licenses that convey rights to digital works. An offer to sell a license is received from a first party, and a bid to buy the license is received from a second party. If the bid meets the requirements of the offer, then a transaction is effectuated wherein the second party acquires the rights signified by the license.

### FIELD OF THE INVENTION

The field of the invention is digital rights management, and in particular a trading system for digital rights.

### BACKGROUND OF THE INVENTION

A digital rights management (“DRM”) system can create and enforce electronic controls on the distribution and use of electronically stored and reproduced works, such as digital music, movies and software files. A work can be made available by a content producer or a content distributor for use by a consumer. In some DRM schemes, a single entity (e.g., a consumer) can also act as a content distributor (i.e., re-distributor). The electronic distribution of works in a DRM system creates opportunities to implement various business models that may not be available for traditional distribution models, such as the known Compact Disc (“CD”) distribution system for electronic works.

A DRM system can control how a work is distributed. It can enforce distribution rules that dictate which entities can distribute (e.g., copy and send the copy of) a work; when and under what conditions it may be so distributed; and what payments, if any, must be made upon distribution. For example, a content producer may distribute a work to content distributors at no cost. When the content distributor sends a copy of the work to a consumer, the consumer must make a first payment to the distributor and a second payment to the producer. The consumer can make a single payment to a clearinghouse, which then makes the appropriate payments to the producer and distributor. As another example, the producer can send the work to the distributor with the proviso that the distributor not send copies to any consumer until after a certain date in the future. The DRM system can enforce this condition.

When a work is used, it is said to be “rendered.” Thus, a digital music file is rendered when it is played as an audible sound signal; a digital photograph is rendered when it is displayed on a monitor; a software program is rendered when it is executed; etc. A DRM system can control how a work is used. It can enforce use rules that dictate which entities can use a work; when and under what conditions the work may be used, and what payments, if any, must be made when the work is rendered. For example, a work can be distributed to a consumer at no cost, but each time the work is rendered, the DRM system causes the consumer to make a small payment to a clearinghouse, which divides the payment among various rights holders with respect to the work (e.g., the producer, the distributor, etc.)

The rules in a DRM system can be expressed in various formats. A known format for expressing such rules is eXtensible rights Markup Language (XrML) published by the ContentGuard Holdings, Inc. XrML is used to formulate “licenses.” A license can be a representation of the conditions under which a work may be distributed and used. It can be associated with a work (e.g., share an identifier with the work) and/or can be physically incorporated into the work, e.g., appended to the work, stored as a watermark in the work, etc. More than one license can be associated with a given work. The conditions of the various licenses can be applied together to the work simultaneously, in a predetermined order, etc. Conflicting requirements of two licenses can be resolved by establishing the priority of one license over another, by prioritizing the individual requirements (conditions) enforced by a license, and other methods.

The terms of a license can be enforced by various controls in a DRM system. At least some of these controls can be implemented in tamper resistant hardware and/or software in various DRM system components, including servers, routers, switches, client devices (e.g., laptops, desktops, cell phones, DVD-players, PDAs, etc.) and so on. The tamper resistant hardware and/or software can prevent the controls (e.g., as expressed in an applicable license) on a work from being circumvented, and can protect the work from unauthorized disclosure, modification, copying and use.

An example of a DRM system is shown in FIG. 1. A content provider 101 that owns legal rights to a given work 102 can issue a publish license 103 (a license pertaining to distribution rights) for the work. The work 102 and the publish license 103 are provided to a content distributor 104 (Step 1). The publish license 103 can specify the rights that a distributor 104 can exercise with respect to copying the work 102 and sending it to others, including, for example, the number of copies the distributor 104 is allowed to create, the lifetime/duration of the grant to publish or disseminate the work 102, the minimal security-level of the consumer device 105 that is permitted to receive a copy of the work 102, payment instructions and other details. Typically, the publish license 103 can identify the distributor 104, and can be digitally-signed by the content provider 101.

For each work 102, the content distributor 104 can provide one or more use-licenses 107 (a license pertaining to use rights) to a clearinghouse 106 (Step 2). A single license can contain both use-license and publish license features. The clearinghouse 106 can refer to a use-license 107 later when a consumer 105 seeks to exercise a right with respect to the work 102 to which the license 107 corresponds. At that time, the clearinghouse can consult the license 106 and either grant or deny the requested use based upon the contents of the license 106. In other DRM systems, the distributor 104 may perform the functions of a clearinghouse.

A use-license 107 can be issued to a consumer by the content distributor 104 (Step 3). In this example, the consumer can send a copy of the use-license 107 to the clearinghouse 106 when the user seeks to exercise a right contained in the license (Step 4). This can be done, for example, over the Internet through a website. The use-license 107 can identify the consumer 105, the instance (the particular copy) of the work 102 and the rights granted. For example, use-license 107 may specify that the consumer 105 may make up to three copies of the work 102; may only render the work 102 up to a fixed number of times; may only render the work 102 on certain predetermined devices; etc. The license 107 can include a digital signature of the consumer 105.

In the system shown in FIG. 1, the work 102 is encrypted using a cryptographic key 109 stored at the clearinghouse 106. When the clearinghouse 106 verifies the use-license 107 and accepts a payment from consumer 105 along with a request from the consumer 105 to exercise a right with respect to work 102, the clearinghouse can send the key 109 to the consumer 105 (step 5). The confidentiality and integrity of the key can be protected in transit, e.g., by encrypting and signing the key. The consumer 105 can use the key 109 to “unlock” (e.g., decrypt) the work 102 and exercise the requested right. The clearinghouse 106 can remit at least some of the payment 108 collected from consumer 105 to content distributor 104 (step 6), while keeping a fee for the clearinghouse services that it provided.

A license can be digitally signed by its issuer, and can authentically identify the various parties associated with the license, e.g., the license creator; distributor; licensee; etc. An example of the structure of a rights-license 201 that can be expressed in XrML is shown in FIG. 2. The grant 202 includes information about the licensee 203, the right being granted 204, the work to which the license pertains 205 and conditions that must be met to exercise the right 206. The issuer 207 includes information about the creator 208 of the license. Issuer Key Information 209 includes public key information relating to the creator 210 and a signature 211 of the entire license 201.

### BRIEF DESCRIPTION OF THE DRAWINGS

FIG. 1 show a prior art example of a digital rights management system.

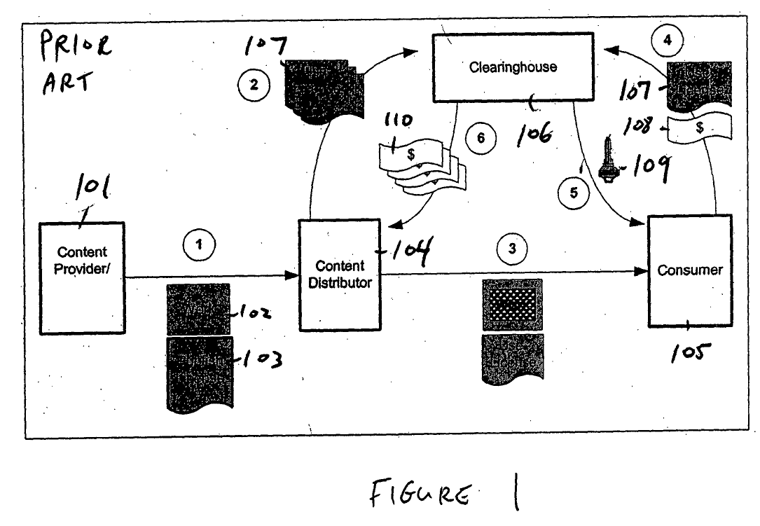

FIG. 2 shows a prior art example of a digital rights license with key information.

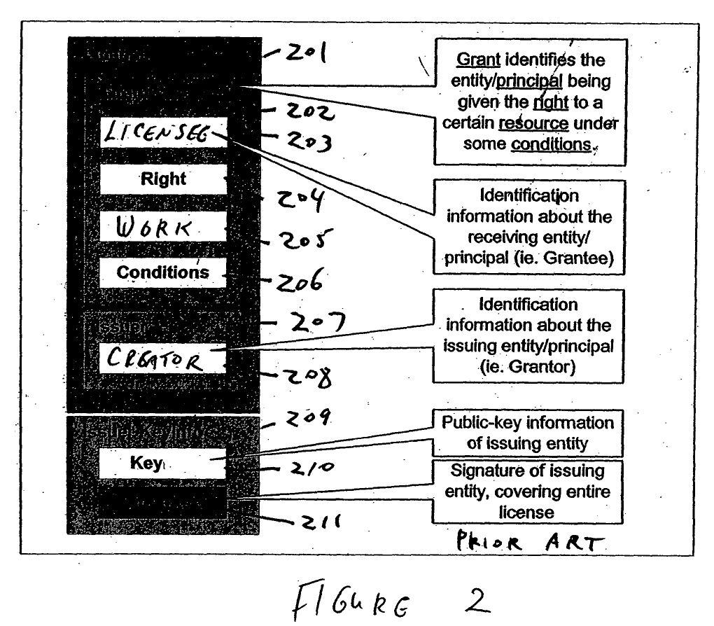

FIG. 3 shows a system in accordance with an embodiment of the present invention.

FIG. 4 shows a system that includes a DRM state repository in accordance with an embodiment of the present invention.

### DETAILED DESCRIPTION

An important privilege of owning property is the ability of the owner to alienate (sell), lend, license, etc., (“trade”) the property in a given market. For example, the owner of a piece of real estate can sell it; lease it for a period of time; permit the property to be used for certain purposes; etc. These uses of property typically involve the exchange of something of value between the owner of the right (e.g., the right to sell, the right to lend, the right to license, etc.) and the grantee of the right. Just as the rights to a piece of real estate can be traded, the present invention sets forth a system and method for trading rights to digital works.

An embodiment of the present invention can advantageously be employed in the trading of any kind of license. The fields of such a license can include the type of license (e.g., Use-License, Publish-License, Trade-License); a serial number or other identifier for the license; the type of Work licensed (e.g. Music, eBooks, Video, Maps, pictures, etc); the identity of the issuer/grantor (e.g., a distributor, a redistributing customer, etc.); the identity of the grantee; a start date and an end-date of the license; a date of issue for the license; requirements and/or conditions to be met for the license to be used; a digital signature, e.g., of the grantor and/or a third party; etc. A license can be digitally signed by its issuer to prevent forgery. Although the license may be backed-up or copied by its possessor (e.g., the grantee), there can be only one valid license.

One example of trading can involve licenses for a Work that is currently available to be used, e.g., played, distributed, etc. For example, a Consumer that has purchased a Use-License for a given musical Work can put it up for sale in a “current licenses market.” The offer to sell can have a specific asking price, and, if the market is run as an auction, a reserve price, an incremental bid size, etc., and all of the rest of the pricing parameters known to auctions. The rights trading system will then perform the purchase/sell transaction on behalf of the two parties. Likewise, a party may trade a current Publish-License in the current licenses market, e.g., for the right to distribute and/or redistribute an associated work.

In one embodiment of the rights trading system, a consumer wishes to sell its valid Use-License for money. For example, the consumer may want to sell the use-license pertaining to a music file that the consumer does not wish to listen to anymore. The consumer can log-on to rights trading system, which can have functionality of an online auction, post the license, establish a reserve, and accept bids. Alternatively, the consumer can post a description of the user-license (e.g., identity of the corresponding work, number of plays left on the license, etc.) and a fixed price. In either event, the rights trading system enables a bidder to make an offer and purchase the use-license. Buyers and sellers can be authenticated by the rights trading system. The rights trading system can also provide an interface to external funds transfer systems, or to a system that authenticates users and effectuates funds transfers, such as PayPal service.

The actual digital works to which the licenses correspond in the rights trading system can reside in separate locations from the licenses being traded, or can be co-located with or attached to their corresponding digital works. In the rights trading system, neither the works nor even the licenses themselves need be part of the market. Rather, participants in the market can offer to sell, license, lend, bid on, etc. rights based upon their descriptions. The actual digital licenses and their corresponding works can be delivered and used outside of the market. It would be advantageous to establish and enforce credential requirements for market participants to avoid spurious and/or fraudulent participants and/or trading activities.

Another example of trading can involve rights that will vest in the future. For example, parties can trade rights to a work that will be produced and/or distributed at some future date, in much the same way commodities future contracts are traded today. For example, a record label announces that it will release a new song (a digital work) by a famous musician and offer only seven principal distribution licenses with the right to sublicense distribution rights. The record label can then offer to sell this future right to distribute in the rights trading system. Interested bidders best positioned to obtain revenue from sublicensees can bid up the price of the licenses and purchase them. This efficient market approach ensures that the seller receives the highest price for the distribution licenses, and that the licenses end up in the hands of buyers best able to widely distribute the work themselves and through sublicensees. When the work is later released, the distribution channels can have already been established to expedite the commercialization of the work.

Likewise, a movie studio can announce that it will release a new work (e.g. digital movie) in the future, and it is selling 100 distribution licenses (publish-licenses), each of which can be used to issue 10,000 use-licenses. The studio can mandate that only distributors participate in the trading of the publish-licenses in the rights trading system. Distributors who purchase the publish-licenses can then accept bids (or simply offer for sale at a fixed price) use-licenses to consumers in the rights trading system. The studio can require each distributor to offer all of the use-licenses for sale at once, or else permit the distributor to parcel them out for sale as it sees fit. Alternatively, the distributor can be permitted a maximum number of licenses that may be offered for sale (e.g., 2000) at any one time. The studio may impose any set of such requirements on the distributor.

The rights trading system can effectuate the transfer of a license in various ways. In one embodiment, a license is anonymous, i.e., it is not associated with a particular consumer, and can be transferred as-is between consumers. Such a license is fungible and resembles electronic cash. For example, a new identifier can be associated with the license delivered to the new owner, and the identifier of the old license can be removed from a “valid license identifier list” stored at a clearinghouse and/or place on a “revoked” list at the clearinghouse. If the old license is sought to be used, then a request is issued to the clearinghouse, which determines that the identifier associated with the license request is on the “revoked” list, and permission to use the work is denied. The new identifier is placed on the “permitted” list at the clearinghouse, and a request to use the work under the new license identifier is granted.

It should be noted that every sale of a license need not require the destruction of the “old” license. For example, a license to use that is owned by a consumer can also include a license to redistribute, with the redistributor receiving a first percentage of the revenue derived from the transfer, and a third party receiving a second percentage, plus revenue paid for each use of the work based upon the work corresponding to the redistributed license. In this case, the consumer who “sells” the license retains its own original functioning copy of the license, and a new license is created for the purchaser. The new license may have the same or different terms (conditions) relating to the use and redistribution of the work.

In accordance with an embodiment of the present invention, fixed-price features are made available along with auction features. For example, a license for sale at a fixed price can be transitioned to an auction-type sale upon the occurrence of certain conditions. For example, if there is no offer to purchase the license at the requested fixed price for a time period set by the seller, then the license can be automatically or manually switched over to an auction-type sale, with or without a reserve, minimum bidding increments, conditions of sale, etc. The time period after such a switch is made can be confidential to the seller. Likewise, a license that is first offered for sale in an auction-type system can be switched automatically or manually to a fixed-price type sale.

When a trade occurs, a new license can be issued by the rights trading system. The new license can, for example, be made based upon the license being transferred. This can be done by, for example, changing the assignee identity (from seller's identity to buyer's); using the current date as the effective use-date of the license; issuing a new serial number (identifier) for the license; including today's date as the date of signing; including the hash of the original license; signing the new license; storing a copy of both the old and new license in secure storage; notifying the clearinghouse of the revoked serial-number belonging to the old license; storing the serial-number of the old/revoked license in a license serial number rights revocation list (RRL), which can be publicly readable.

In one embodiment, the rights trading system identifies and authenticates entities when they participate in the on-line rights trading system. This can be accomplished using strong cryptographic techniques and using strong credentials, such as X.509 public key certificates. When issuing/revoking licenses, the rights trading system can identity the owner of the license not only by the unique name and the Dunn & Bradstreet number, but also by the serial-number of the certificate of the owner. For licenses that may be in effect for a long period of time (e.g. 50 years), the rights trading system can deploy strong keys (e.g. 4096-bit RSA keys) when signing the licenses, or it can re-issue the licenses every few years, e.g., by revoking the existing license and issuing a new one. This can improve the security of the license over the long term.

The rights trading system can verify the validity of all licenses trading in the system, and can verify the correctness and accuracy of all trade-transactions in the system. It can accept submissions of licenses for trading, and verify that each license is valid and from a bona fide member of the trading community. To do this, the rights trading system can verify the information in the license and its associated the digital-signature. The rights trading system can perform transaction settlement operations itself, or interact with an external transactions settlement service provider.

The rights trading system can issue, revoke and manage trade-licenses, which grants the right to trade or traffic in rights licenses to a third party. This is particularly useful for entities such as content distributors and other “license merchants” to identify and authenticate them to the rights trading system. These trade-licenses can also be used to establish other rights trading systems, e.g., a small, semi-autonomous trading system from the system that issues the trade-license. This license, subsidiary trading system can act as a franchisee for licensing trading system, and/or can act as a specialized marketplace for certain types of use-licenses and/or publish-licenses. For example, all use-licenses pertaining to works that have been approved by a third party for viewing by small children can be referred to a subsidiary trading system acting under the terms of trade-license. A trade-license can specify a specific genre of works (e.g. country music); a specific type of work (e.g. films made before 1960); a specific volume of trade (e.g. only maximum 10,000 licenses); etc.

A rights trading system can prevent purchasers and sellers from repudiating a transaction. It can maintain a log of transactions pertaining to a given entity (e.g., content provider, distributor, consumer, etc.) and their trades (e.g., publish-license, use-license, trade-license, etc.) A rights trading system can also maintain a secured back-up copy (e.g., hashed and signed) of a license in order to allow its owner to restore it, in the case that the owner loses it due to a hardware or software failure or other disaster. A backup copy of a license can provide third-party non-repudiation of the ownership of a rights-license. In other words, it can prove to one party that a second party is the legitimate owner/assignee of a given rights-license. Stored transaction details can prove the terms under which a transaction was consummated, and prevent its repudiation.

The rights trading system can accept offers to sell with various requirements (conditions) that must be satisfied to cause a transaction in which a bidder acquires the license. For example, the offer can sell can be made subject to the requirement that bids can only be accepted after a certain date; that the bidder must belong to a certain predetermined class (e.g., consumer, wholesaler, reseller, etc.) that the bidder must meet certain authentication requirements; etc.

Each license can include a unique serial-number, the assignor identity, assignee identity, the permissions-granted, the types of works to which the license can pertain, the duration of the validity of the license, the signature of the assignor, the signature of the rights trading system, etc.

An embodiment of the rights trading system can store copies of the works to which the traded licenses pertain. The works can be stored in a tamper-resistant fashion (e.g., encrypted, hashed and signed) in a facility with the necessary electronic and physical safeguards to protect the works from unauthorized access.

Some licenses can limit the number of times a work can be played, e.g., a song can be played 1000 times only. A trusted entity can enforce this condition by keeping track of the number of times a work has been played. This information can be stored in a DRM State Repository, which can be located at a clearinghouse and be verified by and is accessible to the rights-trading system. The rights trading system can perform the functions of the DRM State Repository (DRM-SR) on behalf of the Content Distributor. Each time the DRM-Client executes/exercises a rights-license, the DRM-Client can securely communicate with the DRM State Repository that should not be able to be repudiated to update the state information pertaining to a given rights-license and work.

When a license-holder indicates to the rights trading system that he wants to trade his license, the rights trading system can verify the state of the license according to the DRM-SR. This can be done to verify ensure that any claim by the license-holder claim regarding a property of the license (e.g., number or exercises left) is correct and true. For example, if a license holder claims that a work has been played 700 times out of, say, a maximum of 1000 possible plays, then the DRM-SR can verify this information, and ensure that it is correctly advertised as part of the offer to trade the license. Verification information from the DRM-SR can be provided to the rights trading system when a request to trade a given license is submitted, or to any requesting third party seeking to verify an advertised state of a license.

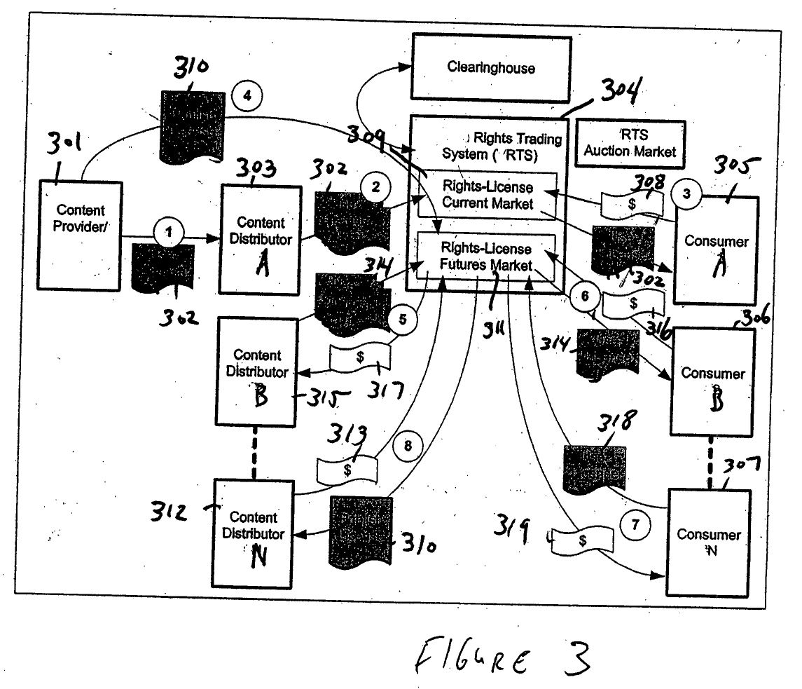

FIG. 3 shows a rights trading system in accordance with an embodiment of the present invention. Content provider 301 sends use-license A 302 to a content distributor A 303. Content distributor A 303 places use-license A 302 up for sale in the rights trading system 304.

For example, use-license A 302 can be placed on auction by the rights trading system 304. The content distributor can register at the rights trading system 304 and create a seller's account, which can be configured to permit the seller to automatically accept credit card payments, debit account payments, etc., which can be through an intermediary such as a bank or other payment clearinghouse. Content distributor A can set a reserve price, below which use-license A may not be sold, and set any other appropriate condition for the sale, e.g., minimum bid increments, conditions that a buyer must meet to be eligible to purchase use-license A, etc.

The use-license can be placed on auction at the rights trading system using a Dutch auction system, e.g., as a part of an offer to sell multiple items. There can be more than one winner in a Dutch auction. All of the winning bidders will pay the same price, which is the lowest successful bid. If there are more bids than there are items (including licenses), the licenses will go to earliest successful bids. To beat another bid, a consumer must have a higher total bid value (the bid price multiplied by the number of items bid on) than other bids. A bidder has the right to refuse partial quantities. Thus, for example, that if a consumer bids for 10 use-licenses and are offered only eight when the auction ends, the consumer doesn't have to buy any of them.

The license can also be placed on sale at the rights trading system for a fixed price. When a consumer wishes to purchase the license, he can pay the fixed asking price and receive the license, provided he complies with any other conditions, if any, for buying the license.

Consumers A 305, B 306 and N 307 can bid on use-license A 302. For example, consumer A 305 can submit a proxy bid to the rights trading system 304. A proxy bid can allow consumer A 305 to submit the maximum amount it is willing to pay for use-license A 302, so that consumer A 305 does not have to continuously watch the auction to increase its bid. The rights trading system 304 can monitor the item for consumer A 305 and submit bids on consumer A's 305 behalf until it has either won use-license A 302 or until another bidder places a bid higher than the maximum bid set by consumer A 305 to pay for use-license A 302.

Rights trading system 304 can collect a fee for placing use-license A 302 up for bid, and can also charge a commission if use-license A 302 is successfully sold. The commission can be a fixed fee, based upon the value received by content distributor A 303 for use-license A (e.g., a percentage, a graduated, sales-price-based rate category, etc.)

Consumer A 305 makes payment 308 to content distributor A (and possibly other parties) through rights trading system 304. In this case, use-license A 302 is traded in a current market 309, meaning that use-license A 302 pertains to rights that can be presently exercised.

Content provider 301 can also place a publish license 310 up for sale at the futures market 311 of the rights trading system 304. In other words, publish license 310 conveys the right to publish a work at some time in the future. Content distributor N 312 purchases publish license 310 at the futures market 311 in exchange for a payment 313. Use-license B 314 is offered for sale at the futures market 314 by content distributor B 315. Use-license B can be bought by consumer B 306 in exchange for a payment 316, all or part of which 317 can be sent to content distributor B 315. Likewise, consumer N 307 can trade use-license C 318 at futures market 311 for payment 319.

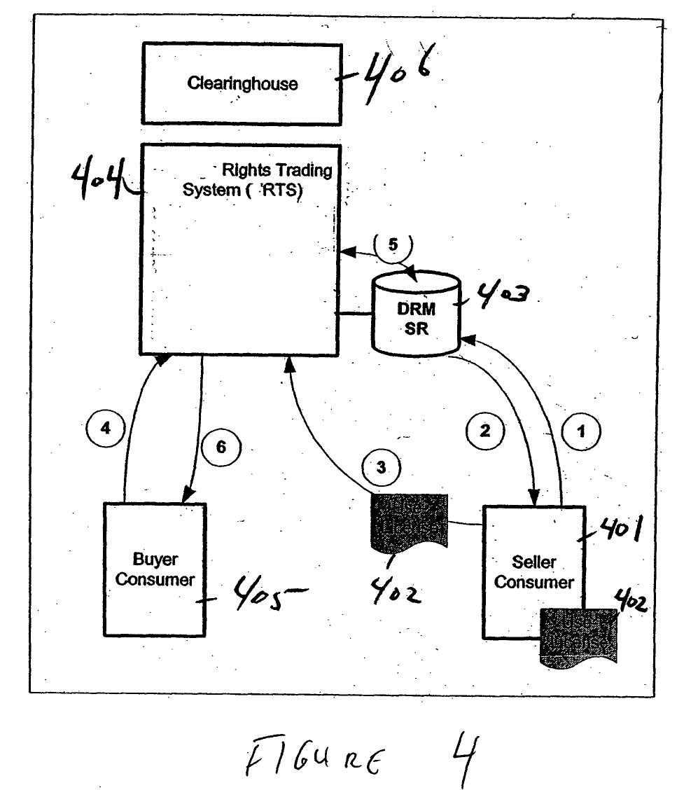

FIG. 4 shows a system that includes a DRM state repository in accordance with an embodiment of the present invention. A seller/consumer 401 that holds a license 402 exercises a right provided by the license 402 using software (DRM client software) resident at the seller/consumer 401. The DRM client software contacts the DRM state repository 403 to update state information pertaining to the license 402, e.g., to change the state of a variable that describes the number of times the work to which the license 402 pertains has been played. The seller/consumer submits the license 402 to the rights trading system 404 to offer the license 402 for sale. A prospective buyer 405 can advantageously request a verification of the state information pertaining to the license 402 from the rights trading system 404. Alternatively, the prospective buyer 405 can query the DRM state repository 403 for this information directly. The rights trading system 404 checks the state information for the license 402 with the DRM state repository 403 and reports the results back to the prospective buyer 405. The functions of the DRM state repository can be performed by a clearinghouse 406.

In accordance with an embodiment of the present invention, licenses can be offered for sale in a rights trading system in a staged fashion to maximize the revenue received from the offerings. For example, a content provider can initially offer for sale a fixed number of licenses to a work, gather information about the response to the offer, and then make a subsequent offer whose parameters are determined at least partly by that information. This can assist the content producer to correctly price the license, and to offer an appropriate number of licenses such that the price is supported. If too many licenses are offered at auction at the rights trading system, the price per license may be too low. If too few licenses are offered for auction, then the revenue generated (the sum of the prices of each license sold) may be too low.

Even if the licenses are not offered at auction, but rather for a fixed price each, information about prior sales can be used to properly price future offerings. For example, the content provider can make available use-licenses N at a time in M releases, e.g., 1000 at a time with 5 releases for a total of 5,000 licenses. A license in the first lot is priced at $10, and every license in the lot is sold within an hour. This tells the provider that the price of the license may be too low. Each license in the next lot (e.g., offered for sale the day after the last license in the first lot was sold) is set at $15. This time, the licenses are all sold within two days. Licenses in the third lot are priced at $20, and not all of the licenses sell. So the remaining licenses are discounted to $15, and sell quickly. Licenses in the next lot are priced again at $15, and sell briskly. In this way, selling the licenses in stages provides both the seller and the buyer to find an optimal price for the license. This makes for an efficient marketplace in which the seller realizes the maximum revenue for its licenses, and the buyers obtains them at the lowest reasonable cost.

Similar staged releases of licenses can be used to determine acceptable pricing at various points in new business models that are possible using the rights trading system. For example, a content provider may sell a license with rights to render the work and to redistribute it, with the redistributor receiving 50 cents per redistributed copy for which a use-license is purchased. The provider can gauge the effectiveness of this pricing strategy by monitoring the rate at which copies are redistributed. For example, the provider can arrange a message to be sent to a clearinghouse each time a copy is redistributed, indicating the sender and recipient. If the rate of redistribution is too low, the provider can increase the reward for redistribution, e.g., to $1 per copy for which a use-license is purchased. If the redistribution rate is high, then the provider can experiment by lowering the redistribution reward, e.g., to 25 cents.

An embodiment of the present invention can be implemented as an apparatus that includes a processor coupled to a memory. The memory stores instructions that are adapted to be executed by the processor to perform the steps in accordance with an embodiment of the present invention. For example, the rights trading system can be implemented on a server having such a processor and memory. The processor can be, for example, a general purpose microprocessor such as the Pentium IV processor manufactured by the Intel Corporation of Santa Clara, Calif. The processor can also be an Application Specific Integrated Circuit (“ASIC”) that implements at least part of the method in accordance with the present invention in hardware and/or firmware. The memory can be any device adapted to store digital information, such as Random Access Memory (RAM), a hard disk, flash memory, etc. The processor can execute rights trading system instructions that are stored in memory to receive an offer to sell a license; receive an offer to buy the license; determine if the offer to buy meets the requirements set forth in the offer to sell (e.g., price, type of buyer, authentication requirements for the buyer, etc.), and if so, can cause a transaction to occur wherein the bidder acquires rights signified by the license. The rights trading server can be coupled to the seller and bidder through a network, such as the Internet. The rights trading server can perform the functions of a clearinghouse and/or a digital rights management state repository and/or store a rights revocation list for revoked licenses. Alternatively, these functions can be performed by separate servers that can be coupled to, and in communication with, the rights trading server through a network.

An embodiment of the present invention can be implemented as a software-based client/server system. An example of a basic software implementation of a rights-management system that uses XrML is the Windows Rights Management Services (RMS) from Microsoft Corp. Although this product is currently tailored for document management, it can be enhanced to handle various other media types and be developed further to be an embodiment of the rights trading system.

In an embodiment of the present invention, a first rights trading system can be used to trade a license that conveys the right to establish a second rights trading system. For example, the license for the second rights trading system can restrict the type of licenses traded in the second system; the customers that can trade in the second system; the prices that can be set and/or accepted for the licenses traded in the second system; conditions under which licenses in the second trading system may be sold; revenue sharing rules for the second trading system; etc.

The second rights trading system can be independent of the first, or disposed in a hierarchical relationship to the first. For example, the rights trading system license for the second rights trading system can specify that the second system can only offer for sale licenses from the first system that failed to attract acceptable bids; that the second system can only sell to consumers outside of the United States; that the second system must remit 50% of its revenues from sales to an agent for the first trading system; that the second system must post its offers and accept its bids in Euros or United States dollars; etc. The rights trading system license can also govern the issuance of sublicenses. For example, a rights trading system license can forbid the issuance of a sublicense to a third party to establish their own rights trading system. Alternatively, the rights trading system license can permit the licensee to issue its own rights trading system licenses to others, subject to various conditions and limitations. Rights trading system licenses can be used to establish large networks of rights trading marketplaces and establish complex relationships among the same. These relationships can define fields of use; revenue sharing; rights to trade in various types of licenses; etc.

The system in accordance with an embodiment of the present invention advantageously provides a flexible marketplace for the trading of rights-licenses, including licenses that pertain to rights that can be exercised presently or at some time in the future. Trade licenses can be issued that delegate authority to third parties to establish their own rights trading systems. Such trade licenses can specify guidelines to which a licensee must adhere to establish such a subsidiary rights trading system. For example, a trade license can restrict the types of works to which traded licenses may pertain; circumscribe the rights that may be traded; and specify a payment scheme to be implemented by the subsidiary rights trading system. Trade licenses can be expressed in the same or a different rights-expression language (e.g., XrML) as other types of license, such as publish licenses and use-licenses. Licensed rights can be managed through the use rights revocation lists, which can, for example, include the identifiers that correspond to revoked rights licenses. State information for licenses can be safeguarded and updated at a DRM state repository, which can be operated by a trusted third party (e.g., as a clearinghouse), the rights management system, etc.

The foregoing description is meant to illustrate, and not to limit, the true scope of the invention. The description makes plain the existence of other useful embodiments to those skilled in the art. These other embodiments are within the scope of the claimed invention.

What is claimed is:

1. A method for trading a license that signifies at least one right to a digital work, including:
receiving from a first party an offer to sell the license;
receiving from a second party an offer to buy the license;
determine if the offer to buy the license meets the requirements of the offer to sell the license; and
causing a transaction in which the license is acquired by the second party if said determination indicates that the offer to buy the license meets the requirements of the offer to sell the license.

2. The method of claim 1, wherein the right conveyed by the license can be exercised by the second party with respect to the digital work commencing from the date and time at which the transaction is completed.

3. The method of claim 1, wherein the right conveyed by the license can be exercised by the second party with respect to the digital work commencing at a future date from the date and time at which the transaction is completed.

4. The method of claim 1, wherein the right pertains to rendering the digital work.

5. The method of claim 1, wherein the right pertains to copying the digital work.

6. The method of claim 1, wherein the right pertains to distributing the digital work to a third party.

7. The method of claim 1, further including:
receiving from a third party a request to verify a property of a license acquired by the second party;
verifying the property;
sending a response based upon the results of said verification to the third party.

8. The method of claim 7, wherein the property is the issuer of the license, and wherein verifying the property includes verifying a digital signature associated with the license to establish if it was made by the purported issuer of the license.

9. The method of claim 7, wherein the property is the integrity of the license, and wherein verifying the property includes verifying a digital signature or a message authentication code associated with the license.

10. The method of claim 7, wherein the property is the owner of the license, and wherein verifying the property includes verifying a digital signature associated with the license to determine if it was made by the purported owner of the license.

11. The method of claim 7, wherein the property is the number of plays left on a license, and wherein verifying the property includes consulting a database that includes the number of plays left on the license.

12. The method of claim 7, wherein the property is the number of copies permitted to be made of a work, and wherein verifying the property includes consulting a database that includes the number of plays left on the license.

13. The method of claim 1, further including
receiving a request to verify the validity of a license;
determining if an identifier of the license is included on a rights revocation list;
sending a response based upon the results of said determination.

14. The method of claim 1, wherein the license includes a distribution license that requires the licensee to make a predetermined number of copies of licenses to use a work available for sale at one time.

15. The method of claim 1, wherein the license includes a distribution license that permits the licensee to make available for sale copies of licenses to use a work in a number and at times that are set at the discretion of the licensee, up to a maximum number of total copies.

16. The method of claim 1, further including:
receiving a request to verify the state of a license;
determining the requested state;
sending a response based upon said determination.

17. The method of claim 1, wherein the first party offers to sell the license at a fixed price.

18. The method of claim 1, wherein the first party offers to sell the license at auction.

19. The method of claim 18, further including receiving from the first party a reserve price below which the license may not be sold.

20. The method of claim 18, wherein the auction is a Dutch auction and the license is offered for sale as a part of an offer to sell a plurality of items.

21. The method of claim 18, further including receiving a proxy bid from the second party, wherein the proxy bid establishes the maximum amount the second party is willing to pay for the license.

22. The method of claim 18, further including receiving a starting bid and a bid increment, wherein the second party's bid for the license is automatically increased to be greater than the next highest bid by at most the bid increment, and less than or equal to the second party's proxy bid.

23. The method of claim 1, further including charging a fixed fee for causing the transaction.

24. The method of claim 1, further including charging a fee that is based upon the value of the transaction for causing the transaction.

25. The method of claim 1, further including charging a fee to the first party for receiving the first party's offer to sell the license without regard as to whether the transaction takes place.

26. The method of claim 1, wherein a requirement of the offer to sell is a minimum price at which the license can be sold.

27. The method of claim 1, wherein a requirement of the offer to sell is that the bidder must be a member of a predetermined class of bidders.

28. The method of claim 1, wherein a requirement of the offer to sell is that the bidder must provide a specified level of authentication to be eligible to submit a bid.

29. A system for trading a license that signifies a right to a digital work, including:
a license trading server that receives an offer to sell a license from a first party and an offer to buy the license from a second party, determines if the offer to sell and the offer to buy are compatible, and if so, effectuates a transaction wherein the rights signified by the license are acquired by the second party;
a clearinghouse server coupled to said license trading server, said clearinghouse storing a license identifier, information regarding the present ownership of the license and a right signified by the license, and an identifier of the license.

30. The system of claim 29, wherein said clearinghouse server further stores a rights revocation list that includes an identifier of a license that has been revoked.

31. An apparatus for trading licenses that signifies at least one right to a digital work, including:
a processor;
a memory coupled to said processor, said memory storing instructions adapted to be executed on said processor to receive from a first party an offer to sell the license, receive an offer from a second party to buy the license, cause a transaction in which the license is acquired by the second party on terms agreeable to both the first and second parties.

32. A medium storing instructions adapted to be executed by a processor to perform actions including:
receiving from a first party an offer to sell the license;
receiving from a second party an offer to buy the license;
determine if the offer to buy the license meets the requirements of the offer to sell the license; and
causing a transaction in which the license is acquired by the second party if said determination indicates that the offer to buy the license meets the requirements of the offer to sell the license.

33. The medium of claim 32, wherein the right pertains to rendering the digital work.

34. The medium of claim 32, wherein the right pertains to copying the digital work.

35. The medium of claim 32, wherein the right pertains to distributing the digital work to a third party.

36. The medium of claim 32, wherein the first party offers to sell the license at auction.

37. A method for trading a license that signifies at least one right to a digital work, including:
sending to a digital rights trading system an offer to sell the license, the rights trading system adapted to receive from a second party an offer to buy the license, and to determine if the offer to buy the license meets the requirements of the offer to sell the license; and
receiving the proceeds of a transaction in which the license is acquired by the second party.

38. A method for trading a license that signifies at least one right to a digital work, including:
receiving from a digital rights trading system a description of a license offered for sale;
sending a bid for the license to the rights trading system;
acquiring the license if the bid is acceptable.
